(19) United States
(12) Patent Application Publication
(10) Pub. No.: US 2007/0077474 A1
(43) Pub. Date: Apr. 5, 2007

(54) Fuel cell system water mass balancing scheme

(76) Inventor: Steven G. Goebel, Victor, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/242,734

(22) Filed: Oct. 4, 2005

(51) Int. Cl. H01M 8/04; H01M 8/02

(52) U.S. Cl. 429/26; 429/38; 429/13

(57) ABSTRACT

A fuel cell system and a scheme for its operation are provided for improving overall water mass balance within the system. In accordance with one embodiment of the present invention, an electrochemical conversion assembly is provided where the coolant flowfield portion defines an operating coolant temperature profile characterized by areas of relatively low coolant temperature T_{MIN} and areas of relatively high coolant temperature T_{MAX}. The cathode flowfield portion and the coolant flowfield portion are configured such that the reactant input and the reactant output are positioned closer to the areas of relatively low coolant temperature T_{MIN} than the areas of relatively high coolant temperature T_{MAX}. In accordance with another embodiment of the present invention, the cathode flowfield portion and the coolant flowfield portion are configured such that the areas of relatively low coolant temperature T_{MIN} are positioned in closer thermal communication with the reactant input and the reactant output than are the areas of relatively high coolant temperature T_{MAX}.

### BACKGROUND OF THE INVENTION

The present invention relates to electrochemical conversion cells, commonly referred to as fuel cells, which produce electrical energy by processing first and second reactants. For example, electrical energy can be generated in a fuel cell through the reduction of an oxygen-containing gas and the oxidation of a hydrogenous gas. By way of illustration and not limitation, a typical cell comprises a membrane electrode assembly positioned between a pair of flowfields accommodating respective ones of the reactants. More specifically, a cathode flowfield plate and an anode flowfield plate can be positioned on opposite sides of the membrane electrode assembly. The voltage provided by a single cell unit is typically too small for useful application so it is common to arrange a plurality of cells in a conductively coupled “stack” to increase the electrical output of the electrochemical conversion assembly.

By way of background, the conversion assembly generally comprises a membrane electrode assembly, an anode flowfield, and a cathode flowfield. The membrane electrode assembly in turn comprises a proton exchange membrane separating an anode and cathode. The membrane electrode assembly generally comprises, among other things, a catalyst supported by a high surface area support material and is characterized by enhanced proton conductivity under wet conditions. For the purpose of describing the context of the present invention, it is noted that the general configuration and operation of fuel cells and fuel cell stacks is beyond the scope of the present invention. Rather, the present invention is directed to particular flowfield plate configurations and to general concepts regarding their design. Regarding the general configuration and operation of fuel cells and fuel cell stacks, applicants refer to the vast collection of teachings covering the manner in which fuel cell “stacks” and the various components of the stack are configured. For example, a plurality of U.S. patents and published applications relate directly to fuel cell configurations and corresponding methods of operation. More specifically, FIGS. 1 and 2 of U.S. Patent Application Pub. No. 2005/0058864 and the accompanying text present a detailed illustration of the components of one type of fuel cell stack and this particular subject matter is expressly incorporated herein by reference.

### BRIEF SUMMARY OF THE INVENTION

A fuel cell system and a scheme for its operation are provided for improving overall water mass balance within the system. In accordance with one embodiment of the present invention, an electrochemical conversion assembly is provided comprising at least one electrochemical conversion cell configured to convert first and second reactants to electrical energy. The electrochemical conversion assembly comprises a reactant supply configured to provide a humidified reactant to a cathode flowfield portion of the assembly and a coolant supply configured to provide a cooling fluid to a coolant flowfield portion of the assembly. The coolant flowfield portion defines an operating coolant temperature profile characterized by areas of relatively low coolant temperature T_{MIN} and areas of relatively high coolant temperature T_{MAX}. The cathode flowfield portion and the coolant flowfield portion are configured such that the reactant input and the reactant output are positioned closer to the areas of relatively low coolant temperature T_{MIN} than the areas of relatively high coolant temperature T_{MAX}.

In accordance with another embodiment of the present invention, the cathode flowfield portion and the coolant flowfield portion are configured such that the areas of relatively low coolant temperature T_{MIN} are positioned in closer thermal communication with the reactant input and the reactant output than are the areas of relatively high coolant temperature T_{MAX}.

In accordance with yet another embodiment of the present invention, a scheme for operating an electrochemical conversion assembly is provided wherein the cathode flowfield portion and the coolant flowfield portion are configured such that the areas of relatively low coolant temperature T_{MIN} are positioned in closer thermal communication with the reactant input and the reactant output than are the areas of relatively high coolant temperature T_{MAX}. In addition, the reactant is humidified to at least about 100% RH at the reactant input and the coolant supply is operated to maintain T_{OUT}, a temperature at said coolant output, no more than about 10° C. above T_{IN}, a temperature at said coolant input.

Accordingly, it is an object of the present invention to provide improved fuel cell systems and a schemes for their operation. Other objects of the present invention will be apparent in light of the description of the invention embodied herein.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is a schematic illustration of an electrochemical conversion assembly according to one embodiment of the present invention;

FIG. 2 is a schematic illustration of an electrochemical conversion assembly according to another embodiment of the present invention; and

FIG. 3 is a graphical representation of relative humidity within the electrochemical conversion assembly as the electrochemical conversion reaction progresses across the assembly.

### DETAILED DESCRIPTION

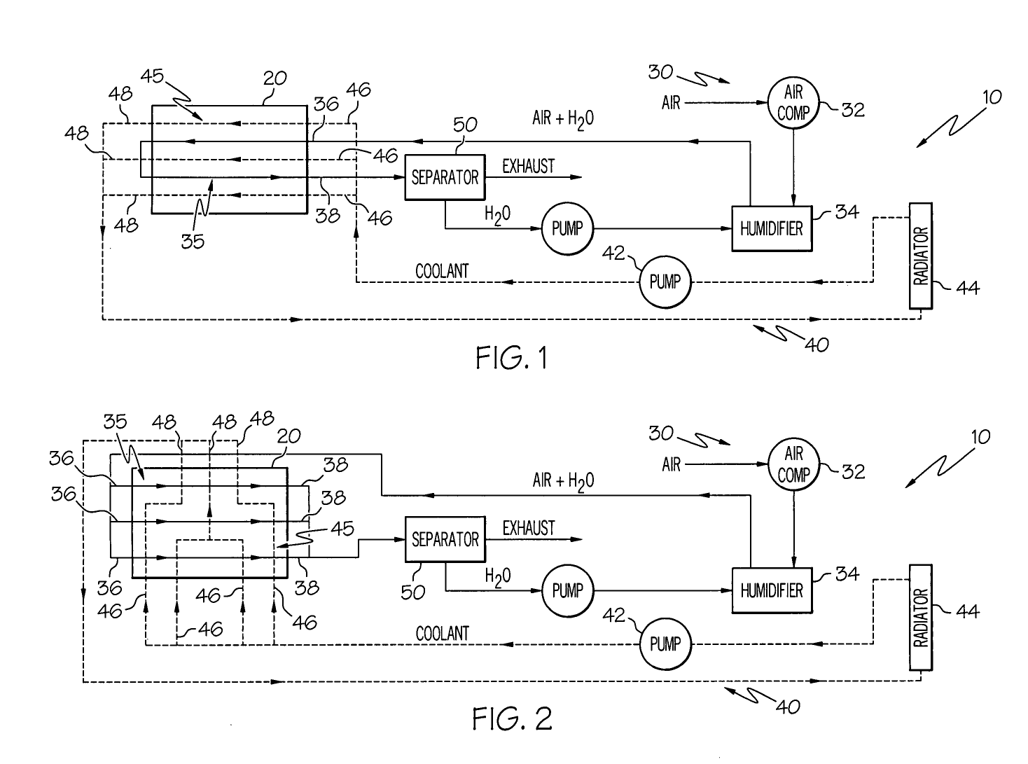

Electrochemical conversion assemblies 10 according to two alternative embodiments of the present invention are illustrated schematically in FIGS. 1 and 2. In each embodiment, the assembly comprises a plurality of electrochemical conversion cells arranged as a fuel cell stack 20. As is noted above, each cell of the stack 20 is configured to convert reactants from respective reactant supplies into electrical energy. The assembly 10 further comprises a cathode reactant supply 30, an anode reactant supply (not shown), and a coolant supply 40.

Although the cathode, anode, and coolant supplies may take a variety of forms within the scope of the present invention, the cathode reactant supplies 30 illustrated schematically in FIGS. 1 and 2 comprise an air compressor 32 and a humidifier 34 configured to humidify the cathode reactant and provide humidified reactant, e.g, air, to the cathode flowfield portions of the fuel cell stack 20. The anode reactant supply, which has been omitted from FIGS. 1 and 2 for clarity, is configured to provide an additional reactant, e.g., hydrogen or a hydrogen-containing gas, to anode flowfield portions of the fuel cell stack 20. The coolant supply 40 illustrated schematically in FIG. 1 comprises a coolant pump 42 and radiator 44 configured to provide a cooling fluid to a coolant flowfield portion of the fuel cell stack 20.

The cathode flowfield portion defines one or more reactant inputs 36, one or more reactant outputs 38, and an array of distinct reactant flow paths 35, each in communication with the reactant inputs 36 and the reactant outputs 38. Similarly, the coolant flowfield portion defines one or more coolant inputs 46, one or more coolant outputs 48, and an array of distinct coolant flow paths 45, each in communication with the coolant inputs 46 and the coolant outputs 48. As will be appreciated by those familiar with fuel cell flowfield design, a typical cathode flowfield will be significantly more sophisticated than that which is illustrated in FIGS. 1 and 2 of the present invention. Specifically, the array of distinct flow paths 35 are merely illustrated schematically in FIGS. 1 and 2 to illustrate the general form of the cathode flow paths 35 in relation to the coolant flow paths 45 defining the coolant flowfield. Typically, the flow paths 35, 45 will include a plurality of inputs and outputs in communication with one or more fluid headers and will be significantly more densely packed and geometrically elaborate than that which is represented in FIGS. 1 and 2.

Regardless of the specific form defined by the cathode and coolant flow paths 35, 45, the coolant flow paths 45 will define an operating coolant temperature profile characterized by areas of relatively low coolant temperature T_{MIN} and areas of relatively high coolant temperature T_{MAX}. The present inventors have recognized that specific operational advantages can be achieved by configuring the cathode flowfield portions and the coolant flowfield portions such that the reactant inputs 36 and the reactant outputs 38 are both positioned closer to the areas of relatively low coolant temperature T_{MIN} than the areas of relatively high coolant temperature T_{MAX}. Stated differently, according to the present invention, the cathode flowfield portion and the coolant flowfield portion can be configured such that the areas of relatively low coolant temperature T_{MIN} are positioned in closer thermal communication with the reactant inputs and outputs 36, 38 than are the areas of relatively high coolant temperature T_{MAX}.

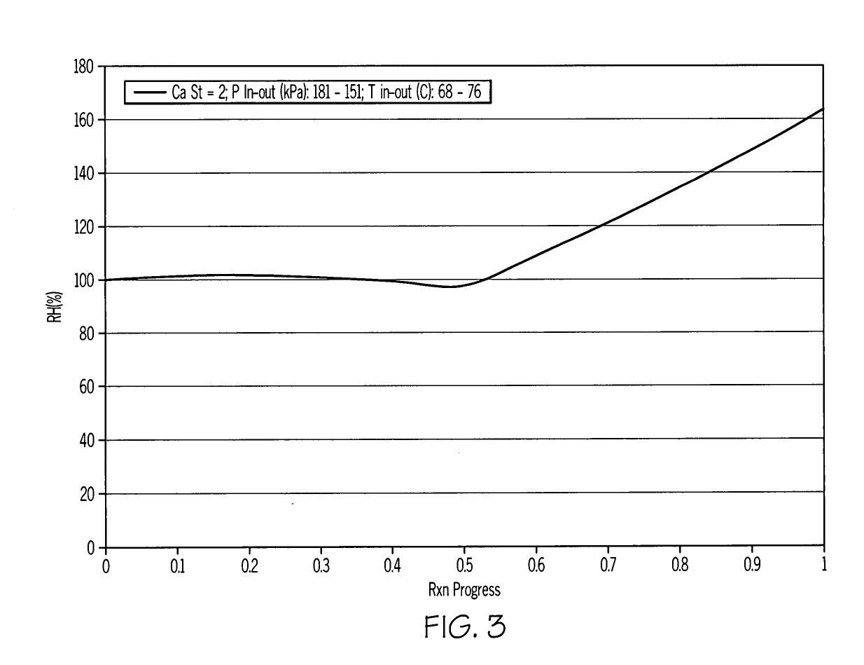

In this manner, overall system water mass balance can be improved because the cathode reactant exits the cathode flow field at a relatively low temperature and can therefore carry less water vapor. In addition, by introducing the cathode reactant into the cathode flow field where temperature is relatively low, less water is required to meet minimum humidification requirements of the stack 20. The approach allows for a higher coolant exit temperature, even under fully humidified inlet conditions where the relative humidity (RH) at the cathode inlets 36 approaches 100%. For example, and not by way of limitation, by configuring the respective cathode and coolant flowfields in the manner described herein, the coolant exit temperature can be maintained at about 76° C., while maintaining the coolant input temperature at about 68° C., the cathode inlet RH at about 100%, and the cathode outlet RH at about 164%. As is illustrated in FIG. 3, which presents a representation of the expected RH profile of a stack operating under these conditions, local humidification levels within the stack are expected to be at least about 100% RH throughout the stack.

To achieve the above-noted ends, the respective arrays of coolant and reactant flow paths illustrated in FIGS. 1 and 2 can be configured such that portions of the reactant flow paths 35 relatively close to the reactant inputs 36 and outputs 38 are positioned in registration with those portions of the coolant flow paths 45 that are relatively close to one or more of the coolant inputs 46. More specifically, referring to the configurations illustrated in FIGS. 1 and 2, the cathode and coolant flowfield portions can be configured such that a cathode reactant moving from the reactant input 36 to the reactant output 38 transitions from a flow pattern that is substantially co-directional with the coolant flow to a flow pattern that is substantially counter-directional with respect to the coolant flow. As a result, the co-directional flow pattern is characterized by a generally increasing coolant temperature profile and the counter-directional flow pattern is characterized by a generally decreasing coolant temperature profile.

As is noted above, an electrochemical conversion assembly 10 can be configured to comprise a plurality of electrochemical conversion cells arranged as a fuel cell stack 20 such that individual active areas of each cell define major faces disposed parallel to each other in the stack 20. As is illustrated in FIG. 1, the coolant inputs 46 and the coolant outputs 48 can be positioned along opposite edges of these major faces while the reactant inputs 36 and the reactant outputs 38 are positioned along respective common edges of the active area face. Thus, the reactant flowfield portion can be described as defining a substantially U-shaped reactant flow pattern. In contrast, the configuration of FIG. 2 includes reactant inputs 36 and reactant outputs 38 positioned along opposite edges of the active area. In FIG. 2, the coolant flowfield portion defines a substantially convergent coolant flow pattern that converges in relative close proximity to the coolant output edge of the active area.

Although the structure of the present invention can be put to use in a variety of manners, in one mode of operation, the humidifier 34 and the coolant supply 30 are configured to humidify the reactant and control the temperature of the reactant flowfield such that the reactant approximates at least about 100% RH at the reactant input 36 and at least about 164% at the reactant output 38. Further, the humidifier 34, the coolant supply 40, and the reactant and coolant flowfields can be configured such that the reactant remains at or above about 100% RH between the reactant input 36 and the reactant output 38. Of course, RH values will vary with operating temperature and pressure.

To enhance RH stability, the humidifier 34, the coolant supply 40, and the reactant and coolant flowfields can be configured to maintain T_{OUT}, a temperature at the coolant output 48, no more than about 10° C. above T_{IN}, a temperature at the coolant input 46. In addition, it is contemplated that the humidifier 34, the coolant supply 40, and the reactant and coolant flowfields can be configured to maintain T_{MAX} less than about 10° C. above T_{MIN}.

Referring specifically to the water separator 50 illustrated in FIGS. 1 and 2, it is noted that the reactant outputs 38 are configured to direct humidified reactant to the water separator 50. The water separator 50 subsequently directs water to the humidifier 34 and exhausts the remainder of the reactant output flow as dehumidified reactant. The humidifier 34 utilizes the water from the water separator 50 to humidify the reactant that is directed to the reactant inputs 36. In this manner, the quantity of additional water needed at the reactant inlets 36 for humidification is recovered at the reactant outlets 38 and re-directed to the reactant inlets. Further, as water is condensed at the reactant outlets 38 and elsewhere in the stack 20, the heat load within the stack is increased by the same amount that is required by the humidifier 34, so the net heat load on the coolant radiator 44 remains unchanged.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. An electrochemical conversion assembly comprising at least one electrochemical conversion cell configured to convert first and second reactants to electrical energy, said electrochemical conversion assembly comprising a reactant supply configured to provide a humidified reactant to a cathode flowfield portion of said electrochemical conversion assembly and a coolant supply configured to provide a cooling fluid to a coolant flowfield portion of said electrochemical conversion assembly, wherein:
said cathode flowfield portion defines a reactant input and a reactant output;
said coolant flowfield portion defines a coolant input, a coolant output, and an operating coolant temperature profile characterized by areas of relatively low coolant temperature T_{MIN} and areas of relatively high coolant temperature T_{MAX}; and
said cathode flowfield portion and said coolant flowfield portion are configured such that said reactant input and said reactant output are positioned closer to said areas of relatively low coolant temperature T_{MIN} than said areas of relatively high coolant temperature T_{MAX}.

2. An electrochemical conversion assembly as claimed in claim 1 wherein:
said cathode flowfield portion comprises an array of distinct reactant flow paths, each in communication with said reactant input and said reactant output;
said coolant flowfield portion comprises an array of distinct coolant flow paths, each in communication with said coolant input and said coolant output; and
said respective arrays of coolant and reactant flow paths are configured such that portions of said reactant flow paths relatively close to said reactant input and said reactant output are positioned in substantial registration with portions of said coolant flow paths relatively close to said coolant input.

3. An electrochemical conversion assembly as claimed in claim 1 wherein said cathode flowfield portion and said coolant flowfield portion are configured such that said areas of relatively low coolant temperature T_{MIN} are positioned in closer thermal communication with said reactant input and said reactant output than are said areas of relatively high coolant temperature T_{MAX}.

4. An electrochemical conversion assembly as claimed in claim 1 wherein said cathode flowfield portion and said coolant flowfield portion are configured such that a cathode reactant moving from said reactant input to said reactant output transitions from (i) a flow pattern that is substantially co-directional, relative to a flow pattern of coolant moving from said coolant input to said coolant output to (ii) a flow pattern that is substantially counter-directional, relative to said flow pattern of coolant moving from said coolant input to said coolant output.

5. An electrochemical conversion assembly as claimed in claim 4 wherein said cathode flowfield portion and said coolant flowfield portion are configured such that a portion of said operating coolant temperature profile associated with said counter-directional flow pattern is characterized by a coolant temperature that decreases as said reactant approaches said reactant output.

6. An electrochemical conversion assembly as claimed in claim 5 wherein said cathode flowfield portion and said coolant flowfield portion are configured such that a portion of said operating coolant temperature profile associated with said co-directional flow pattern is characterized by a coolant temperature that increases as said reactant moves away from said reactant input.

7. An electrochemical conversion assembly as claimed in claim 1 wherein:
said electrochemical conversion cell defines an active area;
said coolant input and said coolant output are positioned along opposite edges of a major face of said active area; and
said reactant input and said reactant output are positioned along a common edge of a major face of said active area.

8. An electrochemical conversion assembly as claimed in claim 7 wherein said reactant flowfield portion defines a substantially U-shaped reactant flow pattern.

9. An electrochemical conversion assembly as claimed in claim 1 wherein:
said electrochemical conversion cell defines an active area;
said coolant input and said coolant output are positioned along opposite edges of a major face of said active area; and
said reactant input and said reactant output are positioned along opposite edges of a major face of said active area.

10. An electrochemical conversion assembly as claimed in claim 9 wherein said coolant flowfield portion defines a substantially convergent coolant flow pattern.

11. An electrochemical conversion assembly as claimed in claim 10 wherein said coolant flow pattern converges in relative close proximity to said coolant output edge of said active area.

12. An electrochemical conversion assembly as claimed in claim 1 wherein said electrochemical conversion assembly further comprises a humidifier configured to humidify said reactant and a coolant supply configured to direct said cooling fluid through said coolant flowfield portion.

13. An electrochemical conversion assembly as claimed in claim 12 wherein said humidifier and said coolant supply are configured to humidify said reactant to at least about 100% RH at said reactant input and at least about 164% at said reactant output.

14. An electrochemical conversion assembly as claimed in claim 12 wherein said humidifier, said coolant supply, and said reactant and coolant flowfields are configured such that said reactant remains at or above about 100% RH between said reactant input and said reactant output.

15. An electrochemical conversion assembly as claimed in claim 12 wherein said humidifier, said coolant supply, and said reactant and coolant flowfields are configured to maintain T_{OUT}, a temperature at said coolant output, no more than about 10° C. above T_{IN}, a temperature at said coolant input.

16. An electrochemical conversion assembly as claimed in claim 12 wherein said humidifier, said coolant supply, and said reactant and coolant flowfields are configured to maintain T_{MAX} less than about 10° C. above T_{MIN}.

17. An electrochemical conversion assembly as claimed in claim 12 wherein said humidifier and said coolant supply are configured to humidify said reactant to at least about 100% RH at said reactant input and to maintain a difference between T_{MAX} and T_{MIN} of below about 10° C. across said coolant flow field.

18. An electrochemical conversion assembly as claimed in claim 1 wherein said electrochemical conversion assembly comprises a plurality of electrochemical conversion cells arranged as a fuel cell stack, a water separator, and a humidifier, wherein:
said fuel cell stack comprises a plurality of cathode flowfield portions, each of which are in communication with said reactant output;
said reactant output is configured to direct humidified reactant to said water separator,
said water separator is configured to direct water to said humidifier and to exhaust dehumidified reactant; and
said humidifier is configured to cooperate with said reactant supply to humidify said reactant.

19. An electrochemical conversion assembly comprising at least one electrochemical conversion cell configured to convert first and second reactants to electrical energy, said electrochemical conversion assembly comprising a reactant supply configured to provide a humidified reactant to a cathode flowfield portion of said electrochemical conversion assembly and a coolant supply configured to provide a cooling fluid to a coolant flowfield portion of said electrochemical conversion assembly, wherein:
said cathode flowfield portion defines a reactant input and a reactant output and comprises an array of distinct reactant flow paths, each in communication with said reactant input and said reactant output;
said coolant flowfield portion defines a coolant input, a coolant output, and comprises an array of distinct coolant flow paths, each in communication with said coolant input and said coolant output;
said coolant flowfield portion comprises an array of distinct coolant flow paths, each in communication with said coolant input and said coolant output and defines and an operating coolant temperature profile characterized by areas of relatively low coolant temperature T_{MIN} and areas of relatively high coolant temperature T_{MAX};
said cathode flowfield portion and said coolant flowfield portion are configured such that said areas of relatively low coolant temperature T_{MIN} are positioned in closer thermal communication with said reactant input and said reactant output than are said areas of relatively high coolant temperature T_{MAX}.

20. A scheme for operating an electrochemical conversion assembly comprising at least one electrochemical conversion cell configured to convert first and second reactants to electrical energy, said electrochemical conversion assembly comprising a reactant supply configured to provide a humidified reactant to a cathode flowfield portion of said electrochemical conversion assembly and a coolant supply configured to provide a cooling fluid to a coolant flowfield portion of said electrochemical conversion assembly, wherein said scheme comprises:
configuring said cathode flowfield portion such that it defines a reactant input and a reactant output;
configuring said coolant flowfield portion such that it defines a coolant input, a coolant output, and an operating coolant temperature profile characterized by areas of relatively low coolant temperature T_{MIN} and areas of relatively high coolant temperature T_{MAX}
configuring said cathode flowfield portion and said coolant flowfield portion such that said areas of relatively low coolant temperature T_{MIN} are positioned in closer thermal communication with said reactant input and said reactant output than are said areas of relatively high coolant temperature T_{MAX}; and
humidifying said reactant to at least about 100% RH at said reactant input.

21. A scheme for operating an electrochemical conversion assembly as claimed in claim 20 wherein said coolant supply is operated to maintain T_{OUT}, a temperature at said coolant output, no more than about 10° C. above T_{IN}, a temperature at said coolant input.

22. A scheme for operating an electrochemical conversion assembly as claimed in claim 20 wherein said coolant supply is operated to maintain T_{MAX} less than about 10° C. above T_{MIN}.

23. A vehicle comprising the electrochemical conversion assembly as claimed in claim 1, wherein said electrochemical conversion assembly serves as a source of motive power for said vehicle.
